(19) United States
(12) Patent Application Publication
(10) Pub. No.: US 2005/0275214 A1
(43) Pub. Date: Dec. 15, 2005

(54) Printed materials with color-change inks to create unique designs

(76) Inventors: Joshua Pokempner, Ann Arbor, MI (US); Jonathan B. Wright, Ann Arbor, MI (US); Kellie Hebert-Folin, Dexter, MI (US)

Correspondence Address: John G. Posa;Gifford, Krass, Groh, Sprinkle,, Anderson & Citkowski, P.C., 280 N. Old Woodward Ave., Suite 400, Birmingham, MI, 48009-5394, US

(21) Appl. No.: 10/866,922

(22) Filed: Jun. 14, 2004

(51) Int. Cl. B42D 15/00

(52) U.S. Cl. 283/95

(57) ABSTRACT

Color-changing inks are used in conjunction with printed material, with defined fields to create unique designs and/or works of art. In the preferred embodiment, pre-printed pages or books are used with fields of invisible inks that are activated with different pens to produce a unique final product. In alternative embodiments, stickers, paints, flocking, foil stamping, thermography, embossing and rubber stamps may be used. In specific embodiments, depictions of cartoon characters or other humans or animals are intermingled with more geometric fields, often with instructions or text explaining to a user what actions should be taken for a desired effect or outcome. Patterns of “invisible inks” having desired properties are pre-printed onto materials according to the invention, such that, through the use of different activator pens, different colors are produced in the various fields, thereby rendering a unique product in each case.

### FIELD OF THE INVENTION

This invention relates generally to color-change inks and, in particular, to pages and books with invisible-ink patterns that are activated to create unique designs.

### BACKGROUND OF THE INVENTION

Color-changing inks and chemistries were invented at least 75 years ago. An early example is U.S. Pat. No. 1,884,197 to H. J. Peterson, which resides in a self-instruction test form involving questions and answers. Referring to FIGS. 5 and 6 of the '197 patent, the answers to the questions are initially invisible and an indicator strip 14 containing a chemical or chemicals or water is applied, the correct answer in a word or words is shown. Separately chemicals or different degrees of concentration may be used to differentiate correct from incorrect responses by diverse changes in gray values or colors when brought into contact with another chemical. For example, a correct answer may be indicated by its accompanying portion changing to red bleaching out or disappearing the incorrect responses changing to blue or being intensified (page 2, lines 11-24). A pen, pin, brush or sponge may be used to apply the chemicals, and the changes may be in form of brightness, hue or saturation, obliteration, etc.

U.S. Pat. No. 2,618,866 to C. S. Adams is another form of educational device, wherein sensitization is accomplished by applying over the examination sheet of material coating of particles of an inorganic clay-like acid material, which is masked by an insulating binder that is pressure-rupturable with a stylus. When the examinee writes over these areas, the overlying organic color-reactant compound particles are driven through and rupture the binder thereon, producing a distinctive color. Color reactions require no moisture or hydroscopic materials, the reaction being entirely on a dry basis.

U.S. Pat. Nos. 3,364,336 and 3,363,338 to Skinner teach devices for handwriting skills. A correct representation of a two-dimensional image is rendered by providing image areas contrasting with a background area. In one example, an area is treated with citric acid and a student is provided with a pen or other device suitable to apply a pH indicator to the paper. The pH indicator may be any of several which change color on contact with the citric acid but Congo red which changes from blue to red at pH is excellent (top of column 7). Other indicators in different pH ranges are also disclosed, as are other chemical formulations.

U.S. Pat. No. 3,438,927 to Ehrlich is directed to improving upon the earlier Skinner patents with respect to commercial printing operations, disclosing that the relative amounts of components such as the type of alcohol and the amount of polyvinyl pyrolidone resin are especially critical.

U.S. Pat. No. 3,454,344 to Ryan et al. is directed to games employing pH-sensitive media, including a first writing medium having a predetermined color and a second writing medium which is substantially the same color as the first. When a medium is then used to write messages on the other which will note become visibly apparent to the naked eye until a pH-sensitive indicator dye is used to produce a predetermined color. U.S. Pat. No. 3,473,807 to Leonard is narrowly directed to a puzzle game in conjunction with certain chemical processes; U.S. Pat. No. 3,617,325 to Spokes et al. resides in impermanent marks that disappear in a short period of time so that exercise books, and the like, can be used over again.

U.S. Pat. No. 3,632,364 to Thomas et al.; and U.S. Pat. No. 3,788,863 to Scheuer use an oxidizing agent to oxidize iodide to reveal a concealed image. Starch or polyvinyl alcohol are contained in the copy sheet, such that when a marking material is applied an intense color is produced, with the system being adaptable to conventional printing systems.

U.S. Pat. No. 3,638,335 to Gunderson et al. is a self-testing device using a color change or formulation with areas that differ from each other and that the color changer development in one area is instantaneous while the change in another area does not become visible for a delayed period of time. Various systems are discussed wherein no color development or formulation takes place outside of a latent image area. An example of such a system utilizes a solution of iodate and iodide in an aqueous solution such that when the marking fluid contacts an image area with its high concentration of acid, an immediate color formulation is obtained, but when the writing solution contacts the background area with a considerably lesser concentration of weak acid, the development color is delayed for some period of time. pH adjustments utilizing manganese and sulfur salts are also disclosed. U.S. Pat. No. 3,677,786 to Hollmann et al. teaches another iodide/iodine formulation.

U.S. Pat. No. 3,701,205 to Wolf is yet another responsive answer/test system where an ink remains invisible until a developing chemical is applied over a response area by a student or other participant. The reaction of the chemical with the invisible ink is such that develops segments of latent markings whenever the student's answer passes over the markings. A visible dye may also be mixed with the developing chemical so that it can be seen along with the writing.

U.S. Pat. No. 3,745,672 to Duskin discloses a sheet of generally ordinary paper is coated with an absorbent reactant including an acidic clay-like material. When a colorless material is brought into contact with the coated paper, a chemical reaction occurs which makes a visible color such as dark blue, bluish green and violet. Oxidizers may be added to slow fading. Paint applicators resembling markers may be used to apply the colors.

U.S. Pat. No. 3,823,022 to Thomas involves the use of leuco dyes and Lewis acids. Either the dye may be formulated into the marking composition or vice versa. For use in pens, felt markers, and the like, to render visible a concealed image. A latent image/hidden entry system is disclosed wherein a paper-like sheet is coated with a microencapsulated reactant which are crushed in selected areas.

U.S. Pat. No. 3,850,649 to Buerkley et al. is a quick set vehicle is mixed with an iron-complexing agent to produce an invisible or concealed image on certain types of paper. Treatment of the image with an iron salt develops the image and makes it visible. U.S. Pat. No. 3,920,863 to Fraik is a latent image, paper-based feedback system based upon dithiooxamide.

U.S. Pat. No. 4,084,332 to Waloszyk et al. is a reactive dye, a stable dye, and an activator are deposited on a substrate, and a solvent, such as water, is used to cause the reactive dye to significantly change or lose its color, thereby providing a visible affect which is different than that created by the original combination of the stable and reactive dyes in an adjoining area, for example. The use of pH level is discussed at column 6, lines 19-26. Note that the marking pen can also includes its own “starting ink,” such that an array of different colors can be produced with a lesser number of marking implements.

U.S. Pat. No. 4,111,462 to Lange et al. provides a latent sensitizing ink incorporating a vehicle component that non-polymeric, oleophilic, organic and through an acid ion/cation reaction provides visible color by contact with a color-activating component. Point of novelty appears to be the use of an arrhenius acid.

U.S. Pat. No. 4,139,965 to Curry et al. uses a dye that renders a paper substantially opaque. Marker pens convey a mild acidic solution mixed with a transparent or translucent dye causing a pH shift to render the paper translucent in the area marked. All of the claims require a box-like housing. U.S. Pat. No. 4,188,431 to Sokol et al. is based upon phenolphthalein inks, with improvements to fading time.

U.S. Pat. No. 4,744,113 to Kogut utilizes a sheet of porous paper having a normally invisible image which becomes visible. The precise mechanism is not disclosed with any certainty, and the claims are limited to a toilet-training apparatus.

U.S. Pat. No. 4,889,559 to Goldberg et al. resides in a latent ink wherein different colors may be placed right next to each other without bleeding. The claims are directed to the ink, which include a Redox indicator as the coloring component along with a thickening a film-forming agent and liquid humectant.

U.S. Pat. No. 5,286,061 to Behm uses a developable and visible ink capable of being rendered visible by application of a developing agent for instant lottery tickets, and the like. Various chemistries are applicable, including the oxidation of iodine, and the use of a Lewis ink as disclosed in U.S. Pat. No. 3,823,022. The claims of this patent are limited to game tickets.

U.S. Pat. No. 5,389,426 to Arens et al. is an article such as a game comprising a porous material having a top surface and a dye applied to the porous material beneath the top surface. The dye is soluble in an imaging liquid such that when the imaging liquid contacts the top surface of the porous media, it dissolves at least a portion of the dye, making it become visible. Preferably, the imaging liquid is a volatile and colorless and usable on a substrate for making a temporary mark. Thus, the invention is particularly useful in the bingo industry. No mention is made of color change based upon pH level, and the marker does not appear to contain dye or pigment particles in any practical sense.

U.S. Pat. No. 5,443,629 to Saville et al. is directed to a latent image ink particularly for use in printed form such as games and coloring books. An offset lithographic press is used for imprinting a substantial invisible image on a sheet of standard paper. The latent ink is a mixture of potassium ferrous cyanide or other suitable color foxing iron complexing compounds, white ink and varnish. A developing solution such as ferric chloride or ammonium sulfate is substantially added to render the image visible. The claims set forth a kit comprising a printed form and a means of applying the development in the form of a felt tip marking instrument.

U.S. Pat. No. 5,814,579 to Dotson et al. is a layer containing organic dye particles (8) and organic developer particles (10) is deposited or printed on a substrate, preferably as a latent or substantially invisible image. When an imaging device (12) such as a pen containing a suitable solvent is contacted with the printed layer (6), the solvent causes the individual particles to react with one another so that a visible color image is obtained (column 3, lines 8-36). The markers used do not contain inks or pigments, and multiple colors based upon pH level are not disclosed.

U.S. Pat. No. 5,957,458 to Haas et al. requires the contact of two surfaces, using an adhesive layer, for example, causing indicia on a game card, for example, to gradually change or appear over a predetermined period of time (column 4, lines 1-15). No marker is involved.

Many patents in this field of endeavor have issued to Leon G. Lenkoff. U.S. Pat. No. 3,826,499, for example, resides in a game such as tic-tac-toe wherein the multiplicity of defined areas are printed with suitable and visible ink such that distinguishing physical features become apparent when a player selectively fills in a defined area with an appropriate marking pen. For example, the sheets may be treated with a suitable acid or base material which remains substantially invisible and the writing instrument 10 can be provided with appropriate color changing chemical materials. “The particular invisible ink formulation used on the marking sheets and writing instrument does not comprise an essential part of the invention,” and may make use of the formulations in U.S. Pat. No. 1,884,197 to H. J. Peterson; U.S. Pat. No. 2,618,866 to C. S. Adams; and U.S. Pat. No. 3,364,336 to B. F. Skinner.

U.S. Pat. No. 4,212,393 to Lenkoff relates to a “magic” coloring package consisting of printed papers which have various figures outlined in a dark color such as black. The space within the outlined area is printed with a uniform water insoluble ink including one or more latent color soluble materials which may be printed in a pattern of dots. When the insoluble imprints of ink are contacted by a felt tip marker, the water in the pen releases the latent coloring material thereby spreading it on the adjacent locality of the paper (see Abstract). Thus, this invention is not based upon pH-related or other sophisticated color-change chemistry, but rather, simply dissolves water-soluble colors preprinted on the page.

U.S. Pat. No. 4,514,177 to Lenkoff is specifically directed to a quiz game, and U.S. Pat. No. 4,586,714 to Lenkoff et al. involves geometric segments that are removably fastened from one another to another, similar to the idea disclosed in the '703 patent to Lenkoff discussed below.

U.S. Pat. No. 5,160,266 to Landis narrowly claims a learning association game wherein a column of positive statements is matched to a corresponding list of words. Any of several chemical formulations can be employed. For example, the marking sheets can be treated with a suitable acid or base material which remains invisible with an implement (10) being provided with appropriate color-changing chemical materials. According to this reference, it is essential that the invisible figures in the defined block areas remain suitable invisible until marked by a player with an appropriate marking instrument . . . also capable of marking visible responses in the . . . response areas.

U.S. Pat. No. 5,176,460 to Garry specifically directed to a protective cap for a writing instrument. U.S. Pat. No. 5,217,231 to Landis includes the limitation of first and second sets of visual images, each including imaging substantially corresponding with the exception that a preselected portion of at least one is visibly incomplete with the completing portion being printed invisibly to develop spontaneously and “artistically” by marking means. For example, in FIG. 2, the invisible printing includes the tag of a dog, the ear of a pig, the paw print of a cat, and so forth. A participating party, upon observing and studying the images can then artistically visually develop the incomplete portions with the nib of a marking pen. As a further confirmation, scoring means are provided.

U.S. Pat. No. 5,234,344 to Lenkoff is directed to a combination book package assembly including a plurality of sheets, some having information printed in latent form with a visible outline conforming to a “logically and orderly collectible series” of written expressions in conjunction with means to fasten the sheets and marker together into an assembled book package with the sheets being fastened in a random fashion to be arrangeable after the package is opened.

U.S. Pat. No. 5,261,703 to Lenkoff resides in a greeting card wherein a scrambled puzzle is transferred from one area to another in numbered, grid fashion. It appears that the recipient draws the scrambled portions from one side of the open card to the other, or may perhaps cut them out; no evidence of color-changing inks.

U.S. Pat. Nos. 5,486,228; 5,489,331; 5,492,558; and 5,503,665, all to Miller et al., are directed to the use of undercolor and overcolor compositions in a series of continuation-type applications dating back to the early 1990s. In contrast to printed books, a person (i.e., a child) would mark a paper with one marker, followed by another or others to change colors. Generally the undercolorant composition is applied to a substrate so as to leave a colorless mark. The undercolor composition is then written over with an overcolor composition causing a color change. The overcolor composition may itself contain a colorant. In one embodiment, the color changing affects are accomplished by applying a dye that is colorless in the presence of high pH and/or reducing agent that becomes colored as the pH is lowered. In the second embodiment, the color-changing affects are accomplished by employing a dye that is colorless at low pH, but that becomes colored as the pH is raised.

U.S. Pat. No. 5,215,956 to Kawashima includes the limitation of a sticker adhering to a non-printed portion of the paper, the sticker including a concentrated or solidified colorformer which is dissolved through the application of a solvent. As shown in FIGS. 1A and 2B, the sticker 24 includes a concentrated colorformer P which is dried and adhered in a shape of a sheet and by using a paintbrush-type applicator having the brush part containing “city water,” the colorformer P can be dissolved and applied as necessary.

U.S. Pat. No. 5,139,572 to Kawashima provides a game comprising at least one marking sheet, color changing chemical marking means for marking the sheet with at least one section on the marking sheet including two defined area selectable for marking by the marking means. One of the areas is printed with an invisible ink such that when the marker contacts one of the defined areas to determine the presence of the invisible ink, the chemical reaction takes place to make it evident for scoring purposes. The claims are specifically directed to certain games such as tic-tac-toe, naval engagement, and so forth.

### SUMMARY OF THE INVENTION

This invention improves upon the existing art through the utilization of color-change inks in conjunction with printed material, with defined fields to create unique designs and/or works of art. In the preferred embodiment, pre-printed pages or books are used with fields of invisible inks that are activated with different color pens to produce a unique multi-color final product. In alternative embodiments, stickers, paints, flocking, foil stamping, thermography, embossing and rubber stamps may be used.

In specific embodiments, depictions of patterns, cartoon characters or other humans or animals are intermingled with more geometric fields, often with instructions or text explaining to a user what actions should be taken for a desired effect or outcome. Patterns of “invisible inks” having desired properties are pre-printed onto materials according to the invention, such that, through the use of different activator pens, different colors are produced in the various fields, thereby rendering a unique product in each case.

### BRIEF DESCRIPTION OF THE DRAWINGS

FIG. 1A is a drawing that shows a pre-printed page with defined fields, cartoon characters and text portions according to the invention;

FIG. 1B is a drawing that shows the patterns used to create invisible inks in the image of FIG. 1A;

FIG. 2 is a drawing that depicts an alternative embodiment of the invention involving different characters and areas where text could be placed;

FIG. 3 depicts yet a further embodiment of the invention, involving the use of a plurality of more regular geometric areas to be filled in;

FIG. 4 is a drawing that depicts a different embodiment of the invention, using cartoon characters, horizontal lines and fields with coloration instructions; and

FIG. 5 is a drawing of a different, further alternative embodiment of the invention, wherein no characters or text are used.

### DETAILED DESCRIPTION OF THE INVENTION

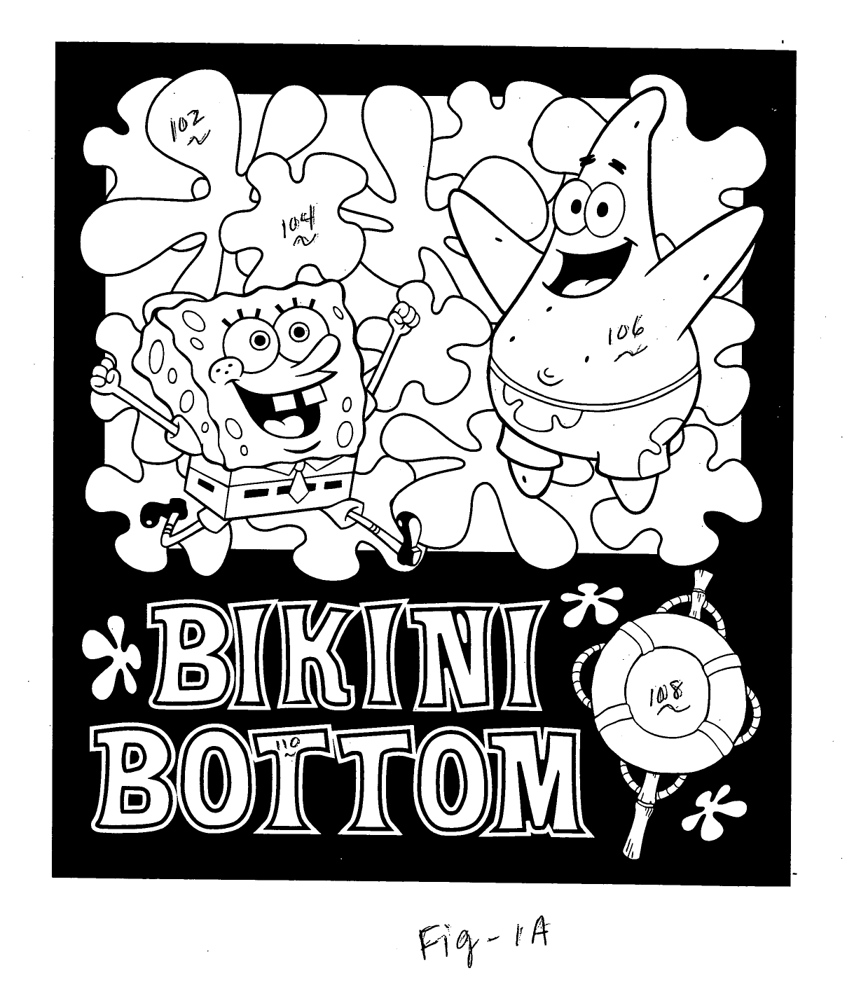

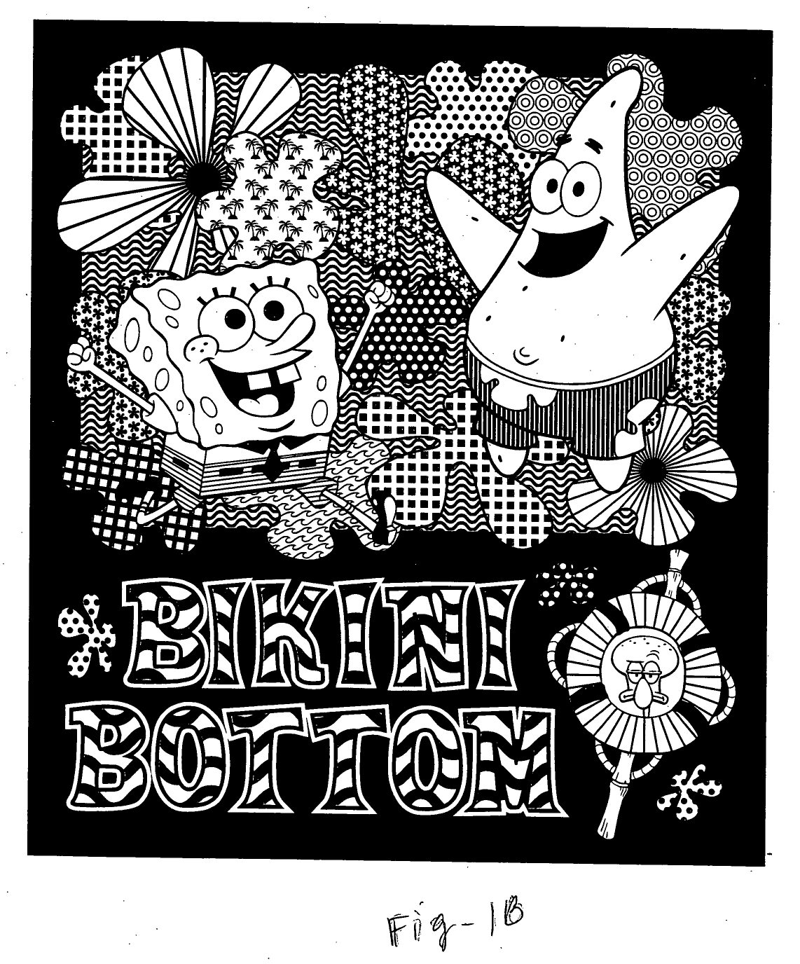

Turning now to the drawings, FIGS. 1A and 1B illustrate one embodiment of the invention utilizing invisible inks which become activated through markers, or the like, with the various areas becoming colored in a unique and novel way. In FIG. 1A, distinct areas are outlined, and within each outlined area latent invisible colorations are laid down as shown in FIG. 1B. For example, in area 102, a white region is shown in FIG. 1A, however, when the invisible ink in this region is activated, a pattern of radially outward extending lines appears, as shown in FIG. 1B. When region 104 is activated, a series of small palm trees appears; in region 108, a person's face becomes visible; and in area 110, wider stripes become visible. Not all regions include latent colors or images, as is evidenced by region 106, which does not include an invisible ink region, such that when colored, it is more like an ordinary coloring book.

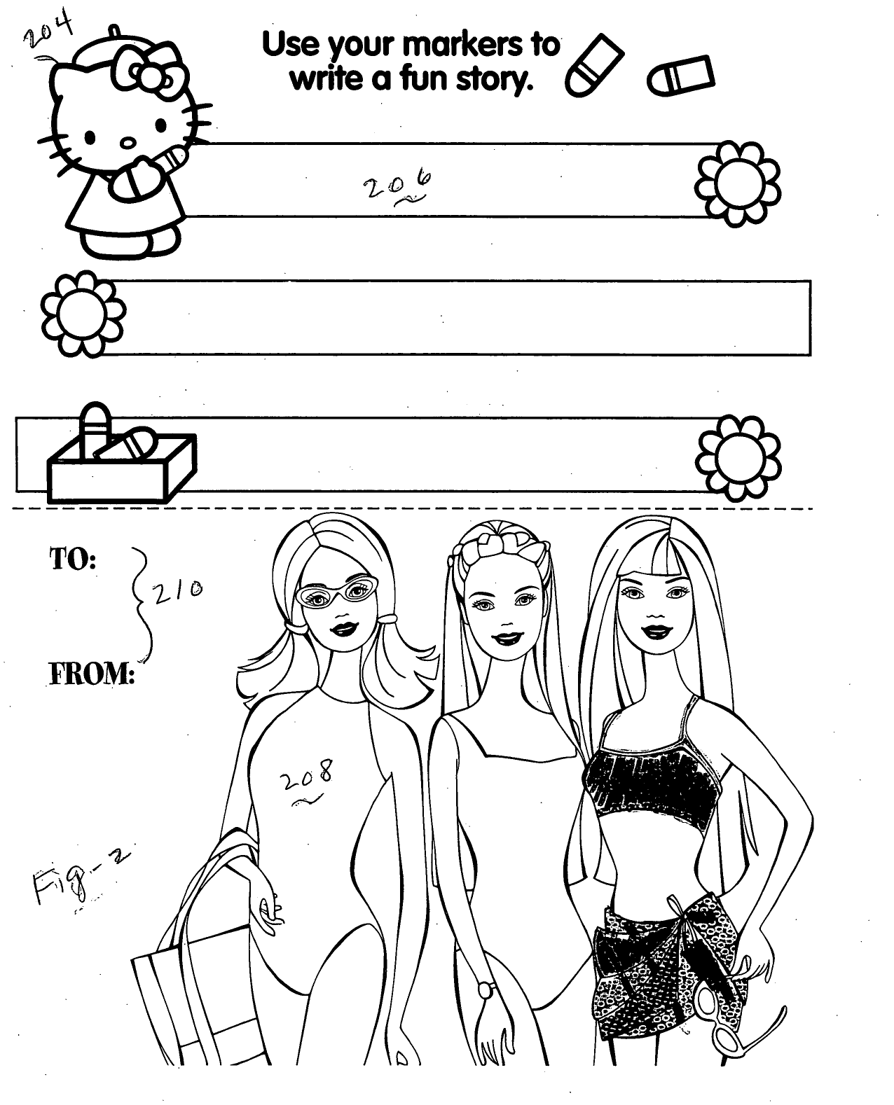

FIG. 2 illustrates a different embodiment of the invention, in the form of a young person's piece of stationary, having an upper section with ornamented lines for a memo, and a lower section with a plurality of female figures and regions 210 providing places for an addressee and a sender. Again, as with the embodiment of FIG. 1, most of the black outlined regions include invisible inks which change color upon activation with a pen, marker, rubber stamp, or the like. Also similar to other embodiments disclosed herein, different colored activator implements are preferably used, such that it is possible for two people to color in the various regions in the same way, thereby creating a unique piece of artwork. That is, using one of the garments of one of the figures 208 as an example, with a first colored activator marker, a first set of two different colors will appear, one associated with the invisible ink and one associated with the area surrounding the ink, whereas with a different marker, a different set of colors will appear, and so forth. This is in contrast to other color-change activity materials, wherein only a particular color will be made visible, such that two people coloring the same page will, in fact, create the same, as opposed to unique affects.

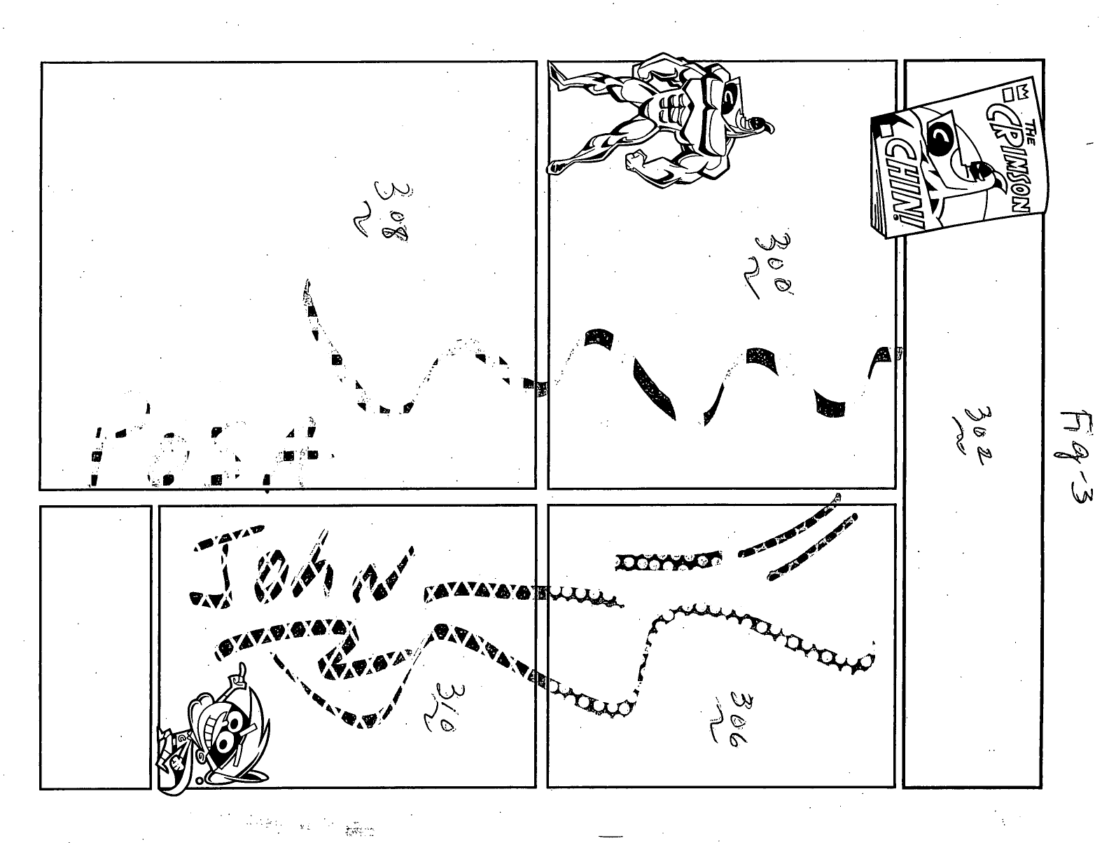

FIG. 3 is a drawing which illustrates a different embodiment of the invention, which has less of an emphasis on figures and succinct lines for textual messages and greetings, instead favoring larger geometric spaces 302, 304, 306, 308, 310. In each one of these geometric spaces, outlined in black, there exists a different pattern of invisible ink, such that a person coloring in these areas with a plurality of different activator pens or markers will create a unique and distinct visual affect.

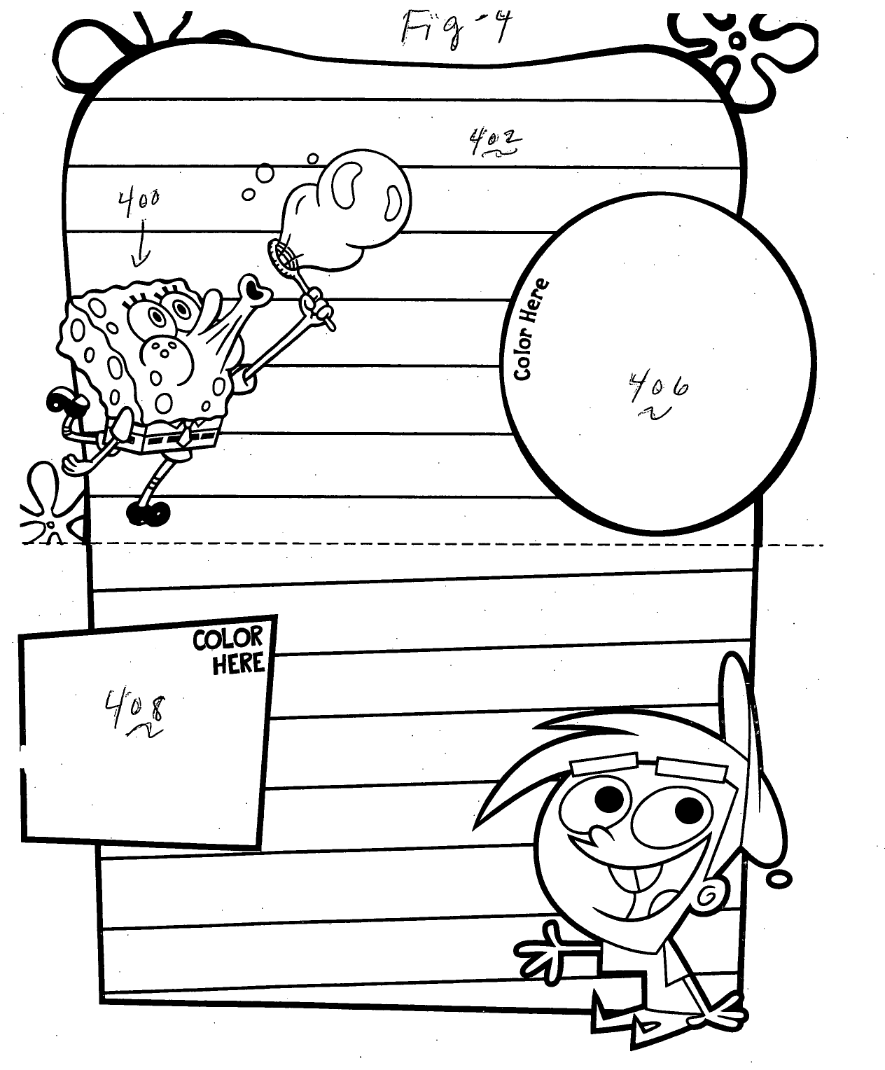

FIG. 4 illustrates yet a further alternative embodiment, including a unique combination of lines for text, 402, characters such as 400, and substantially geometric areas 406, 408. Both the circular region 406 and the rectangular region 408 include invisible inks which are uniquely activated, along with the instructions “color here,” inviting a user to use one or more pens and discover what happens.

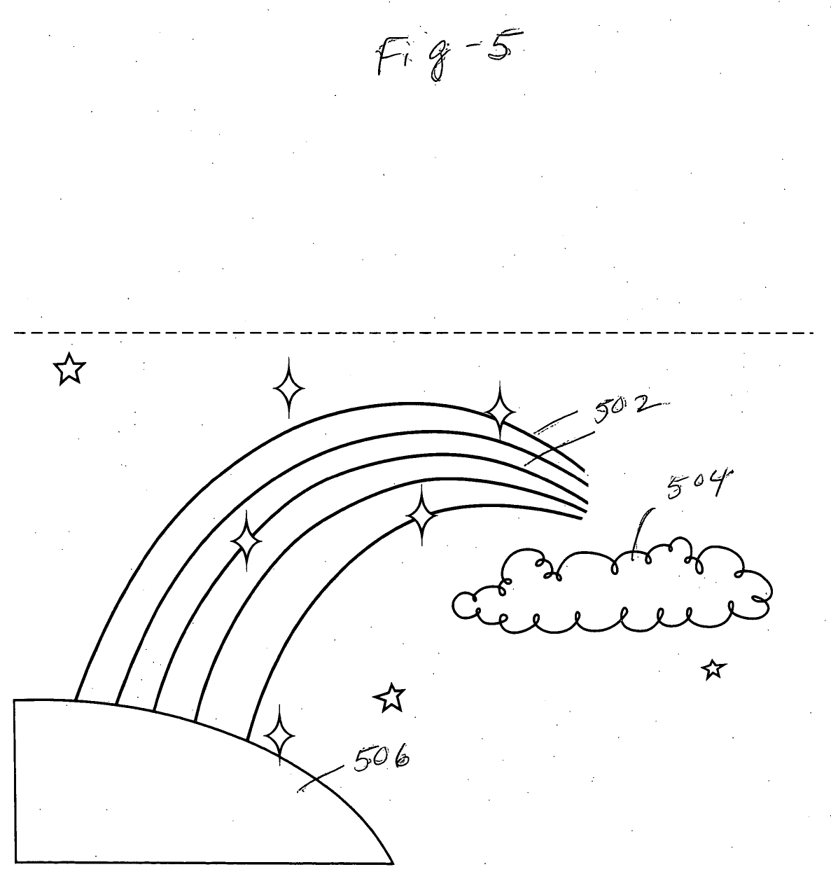

Not all embodiments of the invention necessarily include characters and/or lines of text, as is evidenced by the different embodiment shown in FIG. 5, which includes lines 502 defining a rainbow, outlined region 504 defining a cloud, and 506 defining a horizon. A different pattern of invisible inks are laid down in each of these areas, such that a user may utilize one or more different implements to create regions of multiple colors and varying visual affects.

Nor is the invention limited in terms of ink technology used. Formulations from National Ink, Inc. and other sources are applicable. With regard to paper and ink layer thickness, the following parameters are preferred for many embodiments of the invention:
Printed ink thickness: 0.0009 mm
Drying time: 30 minutes
Plates: Photo polymer
Paper PH: 7.5 (slightly alkaline), 100 gsm offset paper

1. A system for creating a decorative effect, comprising:
at least one substrate;
a plurality of printed outlines permanently visible on the substrate, the outlines creating a plurality of fields;
at least some of the fields containing a preprinted pattern of invisible ink which becomes visible when activated with an activator; and
one or more activators operative to create a unique final design when applied by a user.

2. The system of claim 1, wherein the substrate is a piece of paper.

3. The system of claim 1, including a plurality of substrates in the form of pages in a book.

4. The system of claim 1, wherein the substrate is a sticker.

5. The system of claim 1, wherein the applicator is a marker.

6. The system of claim 1, wherein the applicator is paint.

7. The system of claim 1, wherein the applicator is flocking.

8. The system of claim 1, wherein the applicator is foil stamping.

9. The system of claim 1, wherein the applicator is thermography.

10. The system of claim 1, wherein the applicator is embossing.

11. The system of claim 1, wherein the applicator is a rubber stamp.

12. The system of claim 1, wherein the outlines define one or more cartoon characters.

13. The system of claim 1, wherein the outlines define one or more human or animal figures.

14. The system of claim 1, wherein the outlines define one or more circles, squares or other simple geometries.

15. The system of claim 1, further including one or more preprinted instructions or text explaining to a user what actions should be taken for a desired effect or outcome.

16. The system of claim 1, further including a plurality of different activator pens to produce different colors in the various fields, thereby rendering a unique product with respect to each use.

17. The system of claim 1, wherein the printed ink thickness is on the order of 0.0009 mm.

18. The system of claim 1, wherein the printed ink exhibits a drying time on the order of 30 minutes.

19. The system of claim 1, wherein the substrate is paper having a pH which is slightly alkaline.

20. The system of claim 19, wherein the pH is on the order of 7.5.
